(19) United States
(12) Patent Application Publication
(10) Pub. No.: US 2025/0162140 A1
(43) Pub. Date: May 22, 2025

(54) DEVICE AND ROBOT FOR PERFORMING TASKS AND COMPUTER PROGRAM

(71) Applicant: Deutsches Zentrum für Luft- und Raumfahrt e.V., Bonn (DE)

(72) Inventors: Samuel Bustamante Gomez, Weßling (DE); Jörn Vogel, Weßling (DE); Freek Stulp, Weßling (DE)

(21) Appl. No.: 18/841,251

(22) PCT Filed: Feb. 17, 2023
(86) PCT No.: PCT/EP2023/054010

§ 371 Date: Aug. 23, 2024

(30) Foreign Application Priority Data
Feb. 25, 2022 (DE) 10 2022 104 525.0

(51) Int. Cl. B25J 9/16

(52) U.S. Cl. CPC B25J 9/1602; B25J 9/163; B25J 9/1671

(57) ABSTRACT

The invention relates to a method for performing tasks using a robot, wherein the robot is controlled in a first execution mode and in at least one other execution mode, wherein an action sequence directed towards an action target is generated and executed, and these same action representations are used for controlling the robot in the first execution mode and in the at least one other execution mode; a robot for performing tasks, wherein the robot is designed for carrying out a method of this type; and a computer program comprising program code sections with which a method of this type can be carried out, if the computer program is executed on a control unit of a robot.

This application is a national stage application of PCT Patent Appln. No. PCT/EP2023/054010 filed Feb. 17, 2023, which claims priority to DE Patent Appln. No. 10 2022 104 525.0 filed Feb. 25, 2022, which are herein incorporated by reference.

### BACKGROUND OF THE INVENTION

### 1. Technical Field

The invention relates to a method for performing tasks using a robot, wherein a robot is controlled in a first execution mode and in at least one other execution mode. The invention, moreover, relates to a robot for assisting a user in the performance of tasks. The invention, moreover, relates to a computer program.

### 2. Background Information

DE 10 2017 209 032 A1 relates to a method for controlling a robot. In order to simplify a selection, by a user, of an action to be performed by the robot, DE 10 2017 209 032 Al proposes to determine various actions that can be performed by the robot, to restrict the actions that can be performed by the robot according to at least one precondition and to display this restricted number of actions that can be performed by the robot on a display device so that the user can select an action to be performed from this restricted number.

DE 10 2021 104 883 A1 relates to a method for performing tasks using a robot, wherein a robot is under shared control in a first support mode using a user module and controlled autonomously in a second support mode using an automation module under user supervision. In order to enable user-triggered, adjustable autonomy, particularly in the context of assistive robotics, the user module and the automation module are represented within a shared control module and use the same action representation.

### SUMMARY OF THE INVENTION

The invention is based on the task of providing or structurally and/or functionally improving a method mentioned here above. The invention is, moreover, based on the task of providing or structurally and/or functionally improving a robot mentioned here above. The invention is, moreover, based on the task of providing or structurally and/or functionally improving a computer program mentioned here above.

The problem is solved by a method with the features of claim 1. The problem is, moreover, solved by a robot with the features of claim 14. The problem is, moreover, solved by a robot with the features of claim 15. Advantageous embodiments and/or further developments are the subject of the dependent claims.

The method can be used for controlling the robot. In this context, “controlling” refers, in particular, to controlling using control engineering and/or control technology. Tasks to be performed can be tasks that a user and/or a robot can carry out. The method can be used to control the robot in cooperation with a human user who uses the robot to assist in the performance of tasks (robotic tasks with a human-in-the-loop, RTHL).

In the first execution mode and/or in the at least one other execution mode, the robot can be controlled using a control module. The control module can be a common control module that is configured to control the robot in the first execution mode and in the at least one other execution mode. The control module can be a shared control module. A shared control module can comprise a first submodule and at least one other submodule. A shared control module can comprise a first submodule and a second submodule. A first submodule can be configured to control the robot in the first execution mode. A further submodule can be configured to control the robot in the at least one other execution mode. A first submodule can be implemented as a user module. A second submodule can be implemented as an automation module. In the first execution mode and in the at least one other execution mode, the robot can be assigned different degrees of autonomy. In the first execution mode, the robot can be assigned a lower degree of autonomy than in the at least one other execution mode. In the at least one other execution mode, the robot can be assigned a greater degree of autonomy than in the first execution mode. The first execution mode and the at least one other execution mode can be executed sequentially, weighted sequentially, in parallel and/or weighted in parallel. The method can be executed using at least one processor. The method can be executed using a control unit of the robot.

The first execution mode can be a first support mode. The at least one other execution mode can be a second support mode. A support mode can be configured for performance of tasks using a robot. In the first support mode, the robot can be under shared control. In the first support mode, the robot can be under shared control using a submodule implemented as a user module. The first support mode can also be referred to as “shared control”. In the second support mode, the robot can be controlled autonomously under user supervision. In the second support mode, the robot can be controlled autonomously under user supervision using at least one submodule implemented as an automation module. The second support mode can also be referred to as “supervised autonomy”. The first submodule and the at least one other submodule can be represented within a shared control module. At least one execution mode can be configured for the performance of teleoperations. At least one execution mode can be configured for the performance of fully autonomous operations. At least one execution mode can be configured for “direct control” of the robot.

“Shared control” means, in particular, that the robot, in particular control variables of the robot, can be under shared control of the user using a submodule implemented as a user module and/or autonomously using a submodule implemented as an automation module. The robot can be partially controlled using a submodule implemented as a user module and partially controlled using a submodule implemented as an automation module. A subdivision between a control using a submodule implemented as a user module and a control using a submodule implemented as an automation module can be controllably changeable. A subdivision between a control using a submodule implemented as a user module and a control using a submodule implemented as an automation module can be seamlessly changeable. “Seamlessly” can here mean, in particular, that a change or a switch takes place at least approximately without any influence on the performance of the task. A proportion of control using a submodule implemented as a user module can be between almost 0% and almost 100% and a proportion of control using a submodule implemented as an automation module can be between almost 100% and almost 0%, wherein a proportion of control of a submodule implemented as a user module and a proportion of control of a submodule implemented as an automation module together always amount to 100%. By way of example, approximately 10% of the control can be carried out by the user and approximately 90% by the control unit of the robot. The robot, in particular the control variables, can be controlled proportionally and/or subdivided along the degrees of freedom of movement. Shared control can be understood as a compromise between direct control and supervised autonomy, wherein the user controls only a part of the task directly and continuously, and leaves the rest to the robot.

Supervised autonomy means, in particular, that the user has handed over the performance of a task to the robot and the robot performs the task independently under supervision. Supervised autonomy traditionally comprises two elements: firstly, declarative knowledge in the form of symbols, which knowledge enables the robot to generate an abstract high-level plan; secondly, procedural knowledge in the form of geometric operations, which knowledge assists the robot to create and perform low-level movement plans.

A control module can be a virtual module and/or comprise virtual structures. A submodule, for example, a submodule implemented as an automation module and/or a submodule implemented as a user module, can be a virtual module and/or comprise virtual structures. A submodule, for example, a submodule implemented as an automation module and/or a submodule implemented as a user module, can be a structurally and/or functionally distinguishable or delimitable module. A submodule implemented as an automation module can be configured to autonomously control the robot. A submodule implemented as an automation module can be configured to carry out tasks specified by task definitions. A submodule implemented as an automation module can be configured to generate input commands for autonomous control as an action representation. A submodule implemented as a user module can be configured to control the robot according to user inputs. A submodule implemented as a user module can be configured to generate input commands for shared control as an action representation.

The control module can plan movements and trajectories in the same virtual structures in the first execution mode and in the at least one other execution mode. Input commands of the control module can use the same virtual structures in the first execution mode and in the at least one other execution mode. In the first execution mode, for example, in the first support mode, the robot can be controlled by a user by means of virtual structures, in particular by means of a submodule implemented as a user module. A further submodule, for example, a submodule implemented as an automation module, can plan movements and trajectories in the same virtual structures in which a user generates commands. Input commands of a first submodule, for example, input commands of an automation module, and input commands of at least one other submodule, for example, input commands of a user module, can use the same virtual structures.

A shared control module can comprise a submodule implemented as an automation module and a submodule implemented as a user module. A submodule implemented as an automation module can be integrated into a submodule implemented as a user module. A submodule implemented as a user module can comprise a submodule implemented as an automation module. In this respect, a shared control module can also be referred to as “shared control with integrated autonomy (SCIA)”.

A submodule and a further submodule, for example, a submodule implemented as a user module and a submodule implemented as an automation module, can use the same action representations with their respective input commands. A submodule, for example, a submodule implemented as an automation module, can use the action representations of a further submodule, for example, a further submodule implemented as a user module. A submodule, for example, a submodule implemented as a user module, can use an action representation of a further submodule, for example, a further submodule implemented as an automation module. The action representations can be virtual structures and/or comprise virtual structures.

Within the control module, output commands for controlling the robot can be generated based on input commands. Within a shared control module, output commands for controlling the robot can be generated based on input commands of a first submodule, for example, a submodule implemented as an automation module, and/or on input commands of at least one other submodule, for example, a submodule implemented as a user module. The output commands can also be referred to as a robot control signal. The input commands can be commands within the common or shared control module. The input commands can be commands issued by the control module, for example, by a submodule implemented as an automation module and/or by a submodule implemented as a user module. The input commands can be commands from which output commands are generated. The output commands can be generated directly based on input commands of the control module, for example, based on input commands of a submodule implemented as an automation module and/or on input commands of a submodule implemented as a user module. The output commands can be generated without separate output commands of the control module, for example, without separate output commands of a submodule implemented as an automation module and/or output commands of a submodule implemented as a user module.

The output commands can be generated according to an active execution mode, for example, according to an active support mode. In a first support mode, the output commands can be generated based on input commands of an automation module and/or based on input commands of a submodule implemented as a user module. In a second support mode, the output commands can be generated based on input commands of a submodule implemented as an automation module. The output commands can be output commands of the common or shared control module. The output commands can be commands to control the robot. The output commands can be commands that are sent to the robot to control the robot.

Within the common or shared control module, it is possible to switch between the first execution mode and the at least one other execution mode based on input commands of the control module, for example, based on input commands of a submodule implemented as an automation module and/or on input commands of a submodule implemented as a user module. A submodule, for example, an automation module, can be activatable and/or deactivatable. A switch between the first execution mode and the at least one other execution mode, for example, between a first support mode and a second support mode, can take place in traded control. In this respect, a shared control with switching between the first execution mode and the at least one other execution mode, for example, between a first support mode and a second support mode, can also be referred to as “shared and traded control”. A communication of the input commands of a first sub-module, for example, an automation module, and/or the input commands of at least one other sub-module, for example, a user module, can take place within a shared control module, in particular within virtual structures that a user also uses for input.

A switching between the first execution mode and the at least one other execution mode, for example, between a first support mode and a second support mode, can take place by activation/deactivation of a submodule implemented as an automation module. In the first execution mode, for example, in a first support mode, a submodule implemented as an automation module can be deactivated. In the at least one other execution mode, for example, in a second support mode, a submodule implemented as an automation module can be activated. A submodule implemented as an automation module can be deactivated, by default. A submodule implemented as an automation module can be activated and/or deactivated by a user command.

For further technological background, reference is made to the publications “S. Bustamante, G. Quere, K. Hagmann, X. Wu, P. Schmaus, J. Vogel, F. Stulp, and D. Leidner, “Toward seamless transitions between shared control and supervised autonomy in robotic assistance,” IEEE Robotics and Automation Letters, vol. 6, no. 2, pp. 3833-3840, 2021.” and “G. Quere, A. Hagengruber, M. Iskandar, S. Bustamante, D. Leidner, F. Stulp, and J. Vogel, “Shared Control Templates for Assistive Robotics,” in 2020 IEEE International Conference on Robotics and Automation (ICRA), Paris, France, 2020, p. 7.”, the features of which are also part of the teachings of the present invention and which are fully incorporated into the disclosure of the present invention.

The action target can be a performance or a fulfillment of a specific task. The action target can be an overall target. The action target can be achievable through the performance of suitable actions. The action target can be achieved by sequential performance of suitable actions. The actions to be performed and/or performed to achieve the action target can form the action sequence. The action sequence can comprise actions to be performed and/or performed to achieve the action target or be formed by these actions. The action sequence can be a symbolic plan. The symbolic plan can contain all symbolic transitions which are required to achieve the action target. The action sequence directed to an action target can be an action sequence configured to fulfill the action target. The action sequence can be generated and/or performed to achieve the action target. The action sequence can be neither predetermined nor fixed. The action sequence can be planned to achieve an action target. The action sequence can be individually planned to achieve a specific action target. At least one action and at least one other action of the action sequence can be performed at least partially in parallel to one another.

The action target can be determined taking into account a user command. The user command can be based on an input and/or a selection by a user. The following steps can be carried out for a selection by the user: determination of possible action targets; restriction in a number of the determined possible action targets taking into account at least one precondition; offering of the restricted number of action targets to enable a selection for the user. The restricted number of action targets can be offered to the user by displaying them on a display device.

The precondition can be a global precondition, which states in particular that an action sequence directed at an action target can only be performable after a required preceding action sequence has been completed. The precondition can state that an action sequence can be completed with a restricted number of actions, wherein this number can be adjustable. An action sequence can be defined as an exception and offered to the user for selection, even though the number of actions required to complete that action sequence exceeds a permitted limited number of sequences. The precondition can state that only action sequences on objects to be manipulated are displayed that are less than an adjustable maximum distance away from the robot. A blacklist with impermissible action sequences can be created and the precondition can state that an action sequence on the blacklist can not be offered to the user for selection. A whitelist with required action sequences can be created and the precondition can state that an action sequence on the whitelist must be offered to the user for selection. The precondition can state that the robot can only be used in a limited spatial area, in particular within the home of the user. The precondition can state that the user can only be offered action sequences for selection that do not exceed a predetermined power demand.

For further technological background in this respect, reference is made to the publication “D. S. Leidner, Cognitive Reasoning for Compliant Robot Manipulation, of the series Springer Tracts in Advanced Robotics. Cham: Springer International Publishing, 2019, vol. 127.” the features of which are also part of the teaching of the present invention and which is fully incorporated into the disclosure of the present invention.

An action sequence can be generated using a symbolic planner. Action definitions and/or object definitions can be used when/for generating an action sequence. The action definitions can define actions that can be part of an action sequence. The object definitions can define objects that can be part of an environment of the robot.

Suitable action definitions can be selected from a large number of action definitions when/for generating the action sequence. The action definitions can be contained in an action database. The action database can be a central database. Declarative and/or procedural knowledge can be used when/for generating the action sequence. Declarative and/or procedural knowledge from the action definitions can be used when/for generating the action sequence.

Finite state machines (FSMs) in the form of shared control templates (SCTs) can be created when/for generating the action sequence. The shared control templates can be configured to generate output commands from input commands of the control module, for example, from input commands of a first submodule, for example, an automation module, and/or input commands of at least one other submodule, for example, a user module. The common or shared control module can use shared control templates. States and transitions can form key elements between shared control templates. Each state can represent a different skill phase. Transitions between states can be triggered when certain predefined events occur between objects of interest in the workspace. Input commands of the control module, for example, input commands of a first submodule, such as an automation module, and/or input commands of a further submodule, such as a user module, can be mapped to task-relevant robot movements using the shared control templates. The output commands can be generated by mapping the input commands of the control module, for example, the input commands of a first submodule, such as an automation module, and/or the input commands of a further submodule, such as a user module, to task-relevant robot movements. A shared control template can assist a user in accomplishing a task by providing object- and task-specific mappings and constraints for each state of a skill. In this, the finite state machine can supervise progress and trigger transitions between the different states.

The autonomy can be implemented within a shared control template. The autonomy can use this shared control template. A first submodule, for example, an automation module, can be defined and transmit input commands to the shared control template. During the performance of a task in the shared control with integrated autonomy, a control of the robot can always remain within a shared control template and input authority can be switched between the first submodule, for example, an automation module, and at least one other submodule, for example, a user module. This means that the shared control template is independent of whether input commands come from the first submodule, for example, the automation module, or from the at least one other submodule, for example, the user module. Independently of whether the input commands come from the first submodule, for example, from the automation module, or from the at least one other submodule, for example, the user module, the same state transitions, input assignments, active boundary conditions and/or the same overall control can always be applied.

For further technological background in this respect, reference is made to the publications “S. Bustamante, G. Quere, K. Hagmann, X. Wu, P. Schmaus, J. Vogel, F. Stulp, and D. Leidner, “Toward seamless transitions between shared control and supervised autonomy in robotic assistance,” IEEE Robotics and Automation Letters, vol. 6, no. 2, pp. 3833-3840, 2021.” and “G. Quere, A. Hagengruber, M. Iskandar, S. Bustamante, D. Leidner, F. Stulp, and J. Vogel, “Shared Control Templates for Assistive Robotics,” in 2020 IEEE International Conference on Robotics and Automation (ICRA), Paris, France, 2020, p. 7.”, the features of which are also part of the teaching of the present invention and which is fully incorporated into the disclosure of the present invention.

The method can comprise a planning phase and an execution phase. In the planning phase, a preliminary action sequence can be generated and the preliminary action sequence can be simulated and tested. The preliminary action sequence can be tested with different parameters. In the case of a negative test result, further preliminary action sequences can be repeatedly generated and simulated and tested in the planning phase until a further preliminary action sequence is tested with a positive result. In the case of a positive test result, the preliminary action sequence tested with a positive result or the further preliminary action sequence tested with a positive result can actually be executed as an action sequence in the execution phase.

The robot can be configured to support a user in the performance of tasks. The robot can be an autonomous mobile robot. The robot can be an assistance robot, a humanoid robot, a personal robot or a service robot. The robot can comprise kinematics. The robot can comprise joints and limbs. The robot can comprise actuators and sensors. The robot can have an input and/or output device for a user, which can also be referred to as a user interface. The input and/or output device can be configured to record user commands. The input and/or output device can be configured to offer a user action targets for selection. The input and/or output device can be implemented as a touchscreen. The robot can comprise a control unit. The control unit can comprise at least one processor, at least one main memory, at least one data memory and/or at least one signal interface. The control unit and the input and/or output device can be connected to one another in a signal-transmitting manner. The computer program can be executable using the control unit. The robot can be a real robot. The robot can be a simulated robot or a robot simulation.

The robot can comprise a switching system that is triggerable by the user. The switching system can be used, at any time, to merge input commands of the control module, for example, input commands of a first submodule, such as an automation module, and input commands of at least one other submodule, such as a user module, and/or to switch between input commands of a first submodule, such as an automation module, and input commands of at least one other submodule, such as a user module. A switch between input commands of a first submodule, such as an automation module, and input commands of at least one other submodule, such as a user module, can be initiated by an input command from a user to switch the execution mode, for example, a support mode.

The computer program can be installable and/or executable on a control unit of a robot. The computer program can exist as a computer program product. The computer program can exist on a data carrier as an installable and/or executable program file. The computer program can be used to be loaded into a working memory of a control unit of a robot.

In summary and described in other words, the invention thus provides, among other things, a method for the target planning of robot tasks that are performed under common control, supervised autonomy, or both.

The invention can, in particular, be characterized by the following features:
A planning system for a robot, in particular an assistant robot, which generates handling sequences, which can also be referred to as action sequences, that can be performed both in common control as well as in supervised autonomy. A user can, moreover, switch between these two variants at any point in an execution of a task.
As input, the planning system takes a target, which can also be called an action target, which the user has entered via a user interface, such as a tablet or screen, or selected from a set of options.
During a planning phase, the planning system queries a central database containing actions and their definitions, also called action definitions, and also queries an environmental state. The system uses the declarative knowledge from the actions and creates an action sequence that satisfies the target.
The planning system uses procedural knowledge from the actions and creates finite state machines in the form of shared control templates.
The plans and state machines are simulated and tested with different parameters. If all parameters fail, the planner tries other actions.
In an execution phase, the state machines can be used to perform the action sequences and control the robot, both in the mode of common control, which can also be referred to as first support mode, as well as in the mode of supervised autonomy, which can also be referred to as second support mode.

The flexibility in performing tasks using a robot is enabled or is increased with the invention. A framework for constraint action templates (CATs) is provided that combines action sequences and shared control templates with the main goal of enabling a task plan for common control, in particular, in the first execution mode. The constraint action templates enable symbolic planning of action sequences that can be used jointly to control the robot in a plurality of execution modes and even allow a smooth switch between the execution modes during execution. By way of example, the constraint action templates enable symbolic planning of action sequences that can be used for common control and for autonomous control using a submodule implemented as an automation module and even allow a smooth switch between both control modes during execution.

### BRIEF DESCRIPTION OF THE DRAWING

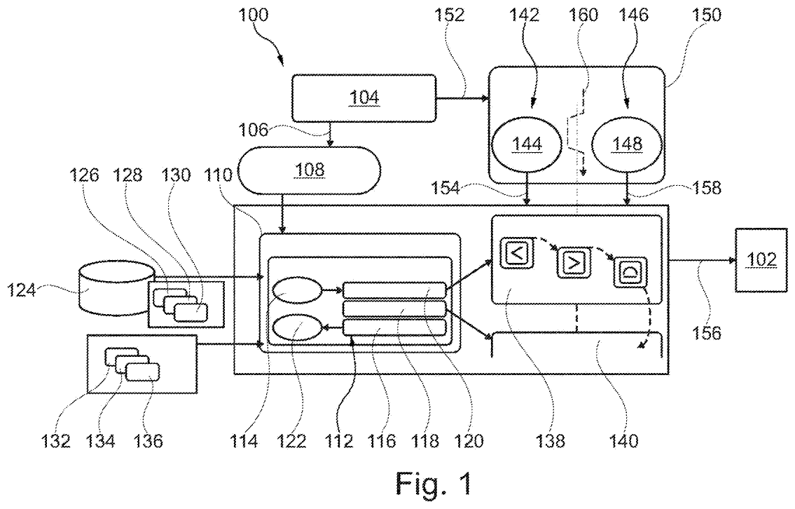

Embodiment examples of the invention are described in more detail hereinafter with reference to FIG. 1, which shows schematically and by way of example a framework for constraint action templates that combines action sequences and shared control templates.

### DETAILED DESCRIPTION

The framework 100 shown in FIG. 1 enables the provision of a robot 102 that flexibly supports a user 104 in a performance of tasks, for example, general tasks, industrial tasks, tasks in aerospace and/or tasks in healthcare, in which purpose-designed plans can be generated for different tasks, the plans can be executed in adapted autonomy levels of the robot 102, including levels of direct control, common control, supervised autonomy and full autonomy, and the user 104 can switch between different autonomy levels during a performance of the plans.

For the performance of a task using a robot, an action target 108 is first determined taking into account a user command 106 and then an action sequence 112 directed at the action target 108 is generated using a task planner 110. The action sequence 112 comprises a start block 114, suitable actions such as action 116, action 118 and action 120, and a target block 122.

To generate the action sequence 112 comprising the actions 116, 118, 120, suitable action definitions such as action definition 126, action definition 128 and action definition 130 are selected from a central database 124, which database contains a large number of action definitions. The selected action definitions 126, 128, 130 are used together with object definitions 132, 134, 136, which define objects of an environment of the robot 102, to create an action sequence 112 that fulfills the action target 108. In this, the task planner 110 uses declarative knowledge from the actions stored in the database 118.

Using procedural knowledge from the actions 116, 118, 120 of the action sequence 112, finite state machines are created in the form of shared control templates, such as shared control template 138 from the action 116 and shared control template 140 from the action 118.

In a planning phase, a preliminary action sequence is generated, simulated and tested with different parameters. In the case of a negative test result, further preliminary action sequences are repeatedly generated, simulated and tested in the planning phase until a further preliminary action sequence is tested with a positive result. In the case of a positive test result, the preliminary action sequence tested with a positive result is actually implemented as an action sequence 112 in an execution phase.

The robot 102 can be controlled in a plurality of execution modes with different degrees of autonomy. In a first execution mode 142, the robot 102 can be controlled in shared control 144. In a second execution mode 146, the robot 102 can be controlled autonomously under user supervision in supervised autonomy 148. The first execution mode 142 and the second execution mode 146 are support modes in this case.

A performance 150 of the action sequence 112 for controlling the robot 102 can take place in shared control 144 taking into account a user command 152 by means of a low-dimensional latent signal xᵤₛₑᵣ as input command 154, which is contextually mapped in the first execution mode 142 as signal x using the shared control templates 138, 140 to task-relevant robot movements to generate a robot control signal u as output command 156.

During the performance of the action sequence 112 in the first execution mode 142, symbolic knowledge relating to the action target 108 can be made available in order to generate a task-oriented process in a latent, low-dimensional space xₐᵤₜ as input command 158 during shared control 144 with the aim of achieving the action target 108.

The input commands 154 and the input commands 158 use the same action representation. In this way, during the performance of the action sequence 112 indicated in FIG. 1 in temporal course 160, a user command 152 to switch to the second execution mode 146 can result in a seamless switch from shared control 144 to supervised autonomy 148 with immediate effect by switching from the signal xᵤₛₑᵣ as input command 154 to the signal xₐᵤₜ as input command 158.

The present action representation-constraint action templates (CATs)-combines in this way the advantages of action sequences, such as action sequence 112, and shared control templates, such as shared control templates 138, 140.

An application example is a system with a robot arm mounted on a wheelchair. The invention enables the user 104 to make complex queries and perform tasks with action sequences 112. If there is a table with a microwave and a cup in the environment of the robot 102, the user 104 can, for example, enter the action target 108 “put the cup in the microwave.” This action target 108 consists of three actions 116, 118, 120 that the robot 102 executes one after the other: open the microwave, take out the cup and put it in the microwave. The robot 102 then executes these actions 116, 118, 120 in the execution phase. The invention can also be implemented in other areas of robotics, for example, in aerospace robots that assist astronauts.

The word “can” refers in particular to optional features of the invention. Accordingly, there are also further developments and/or embodiment examples of the invention which additionally or alternatively comprise the respective feature or the respective features.

If necessary, features can also be selected as required from the combinations of features disclosed in paragraphs [0001] to [0048] of the description and used alone or in combination with other features to delimit the subject matter of the claim, resolving any structural and/or functional relationship that can exist between these features.

### REFERENCE SIGNS

100 Planning framework
102 Robot
104 User
106 User command
108 Action target
110 Task planner
112 Action sequence
114 Start block
116 Action
118 Action
120 Action
122 Target block
124 Database
126 Action definition
128 Action definition
130 Action definition
132 Object definition
134 Object definition
136 Object definition
138 Control template
140 Control template
142 First execution mode
144 Shared control
146 Second/other execution mode
148 Supervised autonomy
150 Performance
152 User command
154 Input command
156 Output command
158 Input command
160 Temporal course

1. A method for performing tasks using a robot, wherein the robot is controlled in a first execution mode and in at least one other execution mode, characterized in that an action sequence directed towards an action target is generated and executed and these same action representations are used for controlling the robot in the first execution mode and in the at least one other execution mode.

2. The method according to claim 1, characterized in that the first execution mode and the at least one other execution mode are executed sequentially or weighted in parallel.

3. The method according claim 1, characterized in that the first execution mode is a first support mode and the at least one other execution mode is a second support mode, wherein the robot is under shared control in the first support mode and is controlled autonomously under user supervision in the second support mode.

4. The method according to claim 1, characterized in that the action target is determined taking into account a user command.

5. The method according to claim 4, characterized in that the user command is based on an input and/or on a selection by a user.

6. The method according to claim 1, characterized in that possible action targets are determined for a selection by the user, a number of the determined possible action targets is restricted taking into account at least one precondition and the restricted number of action targets is offered to the user for selection.

7. The method according to claim 1, characterized in that action definitions and/or object definitions are used when/for generating the action sequence.

8. The method according to claim 1, characterized in that suitable action definitions are selected from a multitude of action definitions when/for generating the action sequence.

9. The method according to claim 1, characterized in that declarative and/or procedural knowledge is used when/for generating the action sequence.

10. The method according to claim 1, characterized in that finite state machines in the form of shared control templates are created when/for generating the action sequence.

11. The method according to claim 1, characterized in that in a planning phase, a preliminary action sequence is generated and the preliminary action sequence is simulated and tested.

12. The method according to claim 11, characterized in that in the case of a negative test result, further preliminary action sequences are repeatedly generated and simulated and tested in the planning phase until a further preliminary action sequence is tested with a positive result.

13. The method according to claim 11, characterized in that in the case of a positive test result, the preliminary action sequence tested with a positive result or the further preliminary action sequence tested with a positive result is actually executed in an execution phase as the action sequence.

14. A robot for performing tasks, characterized in that the robot is designed for carrying out a method according to claim 1.

15. A computer program, characterized in that the computer program comprises program code sections with which a method according to claim 1 can be carried out, if the computer program is executed on a control unit of a robot (102).
